(19) United States
(12) Patent Application Publication
(10) Pub. No.: US 2025/0130539 A1
(43) Pub. Date: Apr. 24, 2025

(54) MACHINE PARAMETER OPTIMISATION USING RANDOM MODIFICATIONS

(71) Applicant: CARGILL, INCORPORATED, Wayzata, MN (US)

(72) Inventors: Amina ALAOUI, Grimbergen (BE); Loic Jean-François AUTRET, Pruillé (FR); Jeremy Anthony Philippe GRUEL, Amstelveen (NL)

(21) Appl. No.: 18/681,398

(22) PCT Filed: Jun. 28, 2022
(86) PCT No.: PCT/US2022/073198

§ 371 Date: Feb. 5, 2024

(30) Foreign Application Priority Data
Aug. 12, 2021 (EP) 21190945.2

(51) Int. Cl. G05B 13/04

(52) U.S. Cl. CPC G05B 13/042

(57) ABSTRACT

Method for optimising a parameter of a machine, comprising: randomly determining a modification value for modifying a current value of the parameter, based on the respective current value of the parameter and on a step size; modifying, at the machine, the parameter to its modification value; evaluating an output of the machine, effected using the modified parameter; fitting a linear function model for the parameter, based on the evaluated output; estimating, using the linear function model, an impact on the output, if the parameter is modified by at least the step size; determining whether or not to modify the parameter, based on a desired output, taking into account the estimated impact; and, if so, modifying the parameter by at least its step size.

### CROSS-REFERENCE TO RELATED APPLICATIONS

This application claims priority to European Patent Application No. 21190945.2, filed Aug. 12, 2021, which is incorporated herein by reference in its entirety.

### FIELD OF THE INVENTION

The present disclosure generally relates to machine parameter optimisation. Specific aspects relate to a method for optimising at least one parameter of a production machine, a computer program for performing such a method, a computer program product storing such a computer program, a computer apparatus comprising such a computer program product, and a production machine operatively coupled to such a computer apparatus.

### BACKGROUND

Production machines, e.g. stretch blow machines, but also other types of production machines, typically have many parameters that can be set to a setting in order to control operation of the production machine. In this way, the machine can produce a product output, but it may also bring about other types of output, which may be interpreted as output signals of the production machine, e.g. noise, heat, electromagnetic radiation, station alignment, machine durability or other maintenance-related signals, consumption of energy (electricity and/or fuel) and/or of other resources such as water and raw materials.

Typically, human operators set these parameters to some setting in order to achieve a desired output. However, this depends on the know-how of experienced operators. Therefore, there may be a problem if less experienced operators are to operate the production machines, who may be less familiar with the relation between settings of the parameters on the one hand and desired output on the other hand. Moreover, in many production facilities, production machines operate for prolonged times, e.g. crossing shift times of operators. This may lead to a problem wherein a new operator or group of operators becomes responsible in a new shift but is less aware of the situation of a production machine during a previous shift, and thus may fail to adequately operate the machine.

U.S. Pat. No. 7,933,679 B1 discloses analysis and optimization of machine processes, by combining and analysing results from finite element analysis, mechanistic modelling and vibration analysis (independently or in combination) of those processes. The overall goal of the analysis and optimization is to determine particular parameters which provide high material removal rate (as the machine process involves milling, drilling, turning and boring) while maintaining reasonable tool life. The cited simulation methods are used to establish acceptance limits for particular process aspects. Machining parameters with results within these acceptance limits are used to update the numerical control (NC) program of the machine. After the NC has been updated, it is validated by shop trials in the machine shop, in order to detect problematic issues related to tool life or part quality.

### SUMMARY OF THE INVENTION

Recently, more and more production machines are being equipped with sensors and are adapted to set their parameters via a computer.

The inventors have identified an opportunity to better formalise and systematise the way that operators operate such production machines, using the sensors and the new ability of computer-set parameters.

It is therefore an aim of aspects of the present disclosure to address this opportunity. It is a further aim of aspects of the present disclosure to overcome any of the problems described above. It is another aim of aspects of the present disclosure to improve operation of production machines in general. If is moreover another aim of aspects of the present invention to do so online, i.e. during operation of the production machine.

In a first aspect, there is provided a method for optimising at least one parameter of a production machine, comprising:
randomly determining at least one modification value for modifying a respective current value of the at least one parameter, wherein the at least one modification value is based on the respective current value of the at least one parameter and on a respective step size predefined for the at least one parameter;
modifying, at the production machine, the at least one parameter to its respective modification value;
evaluating an output of the production machine, wherein the output is effected using the at least one modified parameter;
fitting a linear function model for the at least one parameter, based on the evaluated output;
estimating, using the linear function model, at least one impact on the output of the production machine, for the at least one parameter if the respective parameter is modified by at least the respective predefined step size;
determining whether or not to modify, at the production machine, the at least one parameter by at least its respective predefined step size, based on a desired output of the production machine, taking into account the at least one estimated impact; and
if it is determined to modify the at least one parameter, modifying the at least one parameter by at least its respective predefined step size.

By randomly determining at least one modification value and modifying the at least one parameter thereto, and by evaluating output and taking into account estimated impact of a potential modification of the at least one parameter, the method allows for a noisy optimisation, wherein the random changes allow the method to learn effectively about impact of changing a parameter, whilst still maintaining safe and predictable operation. Due to this noisy optimisation, the method may more easily discover good modifications than if a rigid, static, pre-set plan were followed. Moreover, due to using a linear function model to determine the impact, the consequences of modifying the at least one parameter may more easily be determined due to the relatively simple nature of the model. Furthermore, it may helpfully be assumed that local small changes in the at least one parameter will likely lead to local predictable small changes in the output, which can be efficiently modelled using a linear function model, even if greater changes in the at least parameter might lead to unpredictable changes in the output.

In a further-developed aspect, the at least one modification value is randomly determined in the following range: from at least one respective step size below the respective current value of the at least one parameter to at least one respective step size above the respective current value of the at least one parameter.

In this way, the method may use an efficient range in which to determine random values. Moreover, in this way, advantageously, the at least one modification value may be assumed to be quite close to its respective current value, and therefore may be used to modify that respective current value readily, without incurring a great risk of hindering the operation of the production machine.

In a further-developed aspect, the method comprises repeating the steps of the method over a plurality of iterations.

In this way, the method may arrive at an optimum over time.

In a further-developed aspect, the linear function model is fitted for the at least one parameter further based on at least one previously evaluated output and on at least one previous setting of the at least one parameter of the production machine corresponding with the at least one previously evaluated output.

In this way, the method may take into account historic outputs.

In a further-developed aspect, a sample importance weight of the at least one previously evaluated output and the at least one previous setting decreases over time according to a time-decaying function, preferably an exponentially decaying function.

In this way, the method may take into account the physical and commercial reality that recent outputs trump historic outputs. Additionally, this allows taking into consideration the evolution in time of the optimization of the production machine, in order to give an improved weight to various factors of the production so as to improve optimization.

In a further-developed aspect, the at least one impact is estimated by approximating at least one derivative of the at least one parameter and determining at least one value of the at least one approximated derivative if the respective parameter is modified by at least its respective predefined step size.

In a further-developed aspect, the at least one parameter is a plurality of parameters; and, when based on the above described further-developed aspect, the at least one approximated derivative is a gradient.

In this way, the method allows to interpret the gradient to determine where it leads to better output and thus to determine which parameter or parameters should be modified in which way.

In a further-developed aspect, the method comprises executing a heuristic configured for determining an optimal combination of modifications of the at least one parameter for approaching the desired output, taking into account the at least one estimated impact.

In this way, the method may provide for focusing on parameters whose impact may be greatest, because the heuristic is able to efficiently choose an adequate direction in a context with many parameters. In cases with only a few parameters, a brute force evaluation of all possible parameter combinations remains computationally tractable and may yield the optimal direction.

In a further-developed aspect, determining whether or not to modify the at least one parameter comprises minimising or maximising a loss function, the loss function preferably being based on a sigmoid function and/or a sum over time of differences between the evaluated output and the desired output.

In this way, the loss function may be better explainable, i.e. it may be designed in such a way that its operation and its context can better be made clear to humans, due to the use of readily understandable mathematical functions. Moreover, the sigmoid function and the sum over time may allow for more efficient operation of the method, because both functions allow for fast computation.

In a further-developed aspect, if the steps of the method are repeated over a plurality of iterations, the respective predefined step size changes, preferably decreases, at least once over an iteration of the plurality of iterations.

In this way, the method may include a measure of flexibility in the iterative process. This may advantageously allow to optimise more rapidly initially, but more precisely and more predictably later on, by approaching the minimal step size. If the step size is increased over an iteration, the optimisation may proceed more rapidly and/or the optimisation may overcome a local but non-global optimum, which may for example be advantageous if an optimum is found that actually leads to unsatisfactory output.

In a further-developed aspect, the respective predefined step size is determined for the at least one parameter based on a minimally distinguishable discrete granularity of the at least one parameter at the production machine.

In this way, the step size may correspond with the practical reality of the parameters of the production machine, which may for example only allow particular changes instead of any analogue change.

In a second aspect, there is provided a computer program comprising instructions configured for, when executed on a computer processor, performing the above-described method.

In a third aspect, there is provided a computer program product comprising a computer readable medium storing the above-described computer program.

In a fourth aspect, there is provided a computer apparatus comprising the above-described computer program product and configured for performing the above-described method.

In a fifth aspect, there is provided a production machine operatively coupled to the above-described computer apparatus.

The skilled person will understand that advantages and considerations that apply for the above-described method apply analogously for the computer program, the computer program product, the computer apparatus and the production machine, mutatis mutandis.

### BRIEF DESCRIPTION OF THE DRAWINGS

Aspects of the present disclosure will be more fully understood with the help of the examples described below and with the help of the appended drawings, in which:

FIG. 1 schematically illustrates a flowchart of an aspect of a method according to the present disclosure;

FIG. 2 schematically illustrates a production machine having multiple parameters for optimising using an aspect of a method according to the present disclosure;

FIG. 3 schematically illustrates a graph of a parameter of a production machine being optimised;

FIG. 4 schematically illustrates in four graph panes an example of a loss function for use in an aspect of a method according to the present disclosure;

FIG. 5 schematically illustrates in six graph panes an example of six parameters of a production machine, during operation of an aspect of a method according to the present disclosure; and

FIG. 6 schematically illustrates in four graph panes an example of plastic material distribution of a bottle during operation of an aspect of a method according to the present disclosure.

### DETAILED DESCRIPTION

In the following description, the term production machine may refer to any machine involved in a production process wherein the machine produces a product forming part of its output, and wherein the machine may further effect other outputs, such as signal outputs, e.g. the heat or noise that the machine produces (typically as by-products), or e.g. the resources such as power, materials or production time that the machine consumes in order to produce the product. It is considered that aspects according to the present disclosure may be applicable to any machine having such outputs. In a practical example, it may be preferred if the latency in the production process between modifying a parameter and obtaining an impact on production is relatively short.

In a specific example, a production machine's operation, for example a stretch blow process of a stretch blow machine, may be represented as follows:

$$S ( {P}_{active} , {P}_{passive} , U ) = \{ \begin{matrix}{T}_{top} \\ {T}_{middle} \\ {T}_{bottom} \\ {T}_{base}\end{matrix}$$

with S representing the stretch blow process, Tₜₒₚ, T_{middle}, T_{bottom}, T_{base} the plastic thickness measured respectively at the top, middle, bottom and base of the bottle. P_{active} represent parameters of the process that are modifiable by the optimisation, i.e. parameters which are susceptible to modification by the operator of the production machine, e.g. oven temperature, gas pressure, blow duration, etc. Pₚₐₛₛᵢᵥₑ represent parameters which are available measurements of the process (e.g. exterior temperature), but are not modifiable parameters, i.e. they are—for the purposes of the production process—outside of the power of the operator. Finally U, represents unknown parameters of the process, such as the exact colour of preforms entering the production line (the preforms are the ‘test tubes’ about to be stretched and blown).

### Loss Function

In various examples, it is preferred to use a loss function. Consider the following example loss function:

$$L ( {T}_{top} , {T}_{middle} , {T}_{bottom} , {T}_{base} ) = l$$

L may represent a loss function designed to carry a given order to the optimisation algorithm. In the specific example of a stretch blow process of a stretch blow machine given above, such an order may be “more plastic is needed at the site of the three side wall measurements, and less at the base”). The result of the loss function, l, may be minimised to achieve a more optimal process. Of course, the mathematical definition of the loss function may be opposite, such that the result may have to be maximised to achieve a more optimal process, as will be understood by the skilled person.

In the following, Tₜₒₚ, T_{middle}, T_{bottom}, T_{base} will refer to vectors containing the measurements of a particular output of the production machine; e.g. in the specific example given above this may be thickness measurements of populations of bottles, in the context of stretch blow machines. It is considered implicit that there is available some way of measuring or evaluating the output of the production machine.

In various examples, the value of the loss function may be a sum of sigmoid functions taking as input a collection of such thickness measurements. Sigmoids designed for ordering a plastic increase may be of the form:

$${S}_{P} ( T , s , k , n ) = \frac{s}{1 + {e}^{n ( T - k )}}$$

while those ordering a plastic decrease may be of the form:

$${S}_{N} ( T , s , k , n ) = s + \frac{- s}{1 + {e}^{n ( T - k )}}$$

with T a collection of thickness measurements, s the maximal value of the sigmoid (its minimum is 0), k the location of the sigmoid inflection and n its steepness. S_{P}(T) goes from s to 0 as T increases, S_{N}(T) goes from 0 to s as T increases. Thus:

$$L ( {T}_{top} , {T}_{middle} , {T}_{bottom} , {T}_{base} ) = {\sum }_{T , s , k , n} {S}_{P} ( T , s , k , n ) + {\sum }_{T , s , k , n} {S}_{N} ( T , s , k , n )$$

with Ts one of Tₜₒₚ, T_{middle}, T_{bottom}, T_{base}.

Loss function usage example 1: In a first example, the stretch blow machine producing bottles is in operation and the production process is running and the operator considers that there is not enough plastic on the side wall of the bottle and there is also a possibility to remove some plastic at the bottom, at least up to a certain extent. If measurements on all four locations give an average thickness of, say, 5 units as used in the production process, a loss function may be defined such as:

$$L ( {T}_{top} , {T}_{middle} , {T}_{bottom} , {T}_{base} ) = {S}_{P} ( {T}_{top} ( 1 , 5 , 10 ) ) + {S}_{P} ( {T}_{middle} ( 1 , 5 , 10 ) ) + {S}_{P} ( {T}_{bottom} ( 1 , 5 , 10 ) ) + {S}_{P} ( {T}_{top} ( 1 , 5 , 10 ) ) + {S}_{P} ( {T}_{base} ( 1 , 2 , 10 ) )$$

thus ordering the optimisation algorithm to add plastic to all locations of the side wall, and to disregard the base up to a certain extent. All other things being equal, if measurement readings approach 2 units at the base, the value of the loss function may start to increase. Minimising this example loss function should optimise the dimensions of the bottle.

Loss function usage example 2: In a second example, the stretch blow machine is in operation and the production process is running and the operator considers that the result of the process is satisfactory and should be maintained, e.g. measurements for all locations are at, say, 5 units as used in the production process.

$$L ( {T}_{top} , {T}_{middle} , {T}_{bottom} , {T}_{base} ) = {S}_{P} ( {T}_{top} ( 1 , 4 , 10 ) ) + {S}_{P} ( {T}_{middle} ( 1 , 4 , 10 ) ) + {S}_{P} ( {T}_{bottom} ( 1 , 4 , 10 ) ) + {S}_{P} ( {T}_{top} ( 1 , 4 , 10 ) ) + {S}_{P} ( {T}_{base} ( 1 , 4 , 10 ) ) + {S}_{N} ( {T}_{top} ( 1 , 6 , 10 ) ) + {S}_{N} ( {T}_{middle} ( 1 , 6 , 10 ) ) + {S}_{N} ( {T}_{bottom} ( 1 , 6 , 10 ) ) + {S}_{N} ( {T}_{top} ( 1 , 6 , 10 ) ) + {S}_{N} ( {T}_{base} ( 1 , 6 , 10 ) )$$

This may define a loss function for which average thicknesses of 5 units for all sensors is the global minimum. As the optimisation is running, the algorithm may attempt to maintain the current thicknesses of 5 units, even if U changes over time.

In order to facilitate operation for operators, helpful shortcut commands may preferably be provided, such as stabilise or increase, which may automatically determine which scenario is to be performed.

### Optimisation

The problem of optimising a production machine is a physical problem: evaluating the value of the loss function for a given set of parameters entails that bottles have to be made and measured. By utilising an optimisation method with iterative parameter modifications bounded by their previous state, destructive evaluations may be avoided, in which produced bottles would end up having more than one hole, which may be undesirable.

In an example of an aspect of a method according to the present disclosure, the optimisation may start from a set of parameters resulting in bottles, and the loss function may be designed based on improvements to make to these bottles.

For each P_{active}, a set of bounds may be defined: a minimum value, a maximum value and a step size by which the method is allowed to modify the parameter.

The example of the aspect of the method may proceed as follows:
1. Randomly modify the value of P_{active} parameters a given amount of times (in the current form, if a parameter has value P at the start of that step, and its maximum step size is s, however many random modifications happen, the parameter value will remain within [P−k*s, P+k*s], where k is a natural number, preferably 1).
2. Collect P_{active}, Pₚₐₛₛᵢᵥₑ, Tₜₒₚ, T_{middle}, T_{bottom}, T_{base} from a given point in the past to now.
3. Fit a linear function model (e.g. Ridge regression, although other suitable linear function models may also be used) for each thickness measurement, with as its outputs the thickness measurements, and as its inputs the concurrent values of P_{active} and Pₚₐₛₛᵢᵥₑ. Sample weights in the training set used for fitting the linear function model may preferably decrease exponentially with time.
4. Based on the parameters of the fitted model and assuming a locally linear S, compute the contribution to the various bottle thicknesses of either increasing or decreasing each P_{active} by its step size.
5. Execute a heuristic to determine the best combination of P_{active} modifications to minimise the loss function, i.e. to achieve the maximum loss function reduction.
6. Update P_{active}, i.e. modify the parameters of the production machine.

Optionally, this process may be repeated over a plurality of iterations.
Note on step 1: The random parameter modifications may allow the model fitted in step 3 to capture the contributions of individual P_{active} parameters to the bottle thickness. By using randomly determined modification values for the modification of the parameters, the optimisation process is, in a manner of speaking, more noisy, which advantageously allows the optimisation to learn more effectively. Moreover, by somewhat restricting the range wherein the modification values may randomly be determined, safe and predictable operation may still be maintained, which is important in physical production processes.
Note on step 3: The ultimate goal of the models fitted is not necessarily to make very accurate predictions, hence there may be no need for a classical train/test protocol. The models may be used to approximate the (possibly multi-dimensional) derivative of S at the location of the current set of parameters: the coefficients of the equation describing the fitted model may allow to extract the contribution of P_{active} to the problem. As the optimisation is running, it may be expected that all of P_{active}, Pₚₐₛₛᵢᵥₑ and U will diverge; the older a data point, the less relevant it may be for locally approximating the derivative of S. This aspect may advantageously be handled by the time decaying sample weights in the model fitting phase.

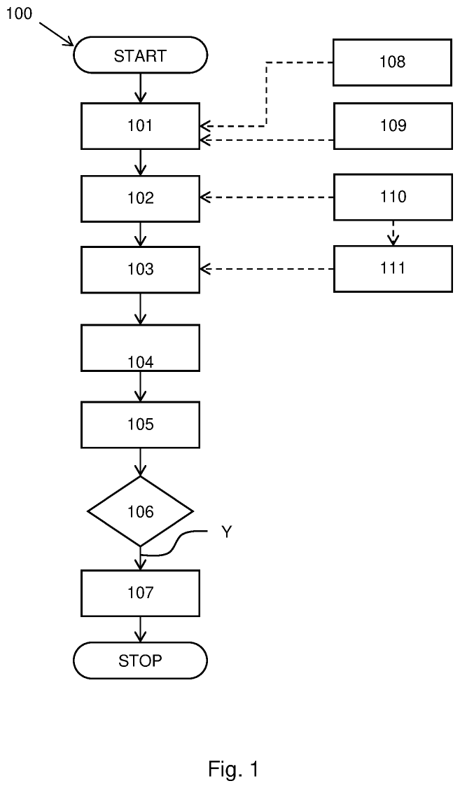

FIG. 1 schematically illustrates a flowchart of an aspect of a method 100 according to the present disclosure. The method 100 is for optimising at least one parameter of a production machine 110, and comprising steps 101-107.

Step 101 comprises randomly determining at least one modification value for modifying a respective current value of the at least one parameter, wherein the at least one modification value is based on the respective current value of the at least one parameter and on a respective step size predefined for the at least one parameter.

The respective current value may be read directly or may be drawn from a repository of current values 108. The respective predefined step size may be drawn from a repository of such step sizes 109.

Step 102 comprises modifying, at the production machine 110, the at least one parameter to its respective modification value.

Step 103 comprises evaluating an output 111 of the production machine 110, wherein the output is effected using the at least one modified parameter.

Step 104 comprises fitting a linear function model for the at least one parameter, based on the evaluated output.

Step 105 comprises estimating, using the linear function model, at least one impact on the output of the production machine 110, for the at least one parameter if the respective parameter is modified by at least the respective predefined step size.

Step 106 comprises determining whether or not to modify, at the production machine 110, the at least one parameter by at least its respective predefined step size, based on a desired output of the production machine 110, taking into account the at least one estimated impact.

Step 107 comprises, if it is determined to modify the at least one parameter, modifying the at least one parameter by at least its respective predefined step size.

In some aspects according to the present disclosure, it may be advantageous to disable or at least design around a built-in control function of the production machine, if the production machine has such a built-in control function to control operation of the production machine, for example to control power delivery to heating elements in order to achieve a set temperature value. The reason for this is that such a built-in control function may otherwise be hindered by and/or may otherwise hinder the operation of those aspects according to the present disclosure. The details of how to implement this disabling or this designing around are left to the skilled person.

In practical aspects of the method according to the present disclosure, the method may for example be implemented as a computer program comprising instructions in a programming language, configured for, when executed on a computer processor, performing the method. The programming language may be any suitable programming language, and may be a high-level programming language such as C, C++, Java, C#, Python or Clojure, or a combination thereof, or may be a machine programming language.

It will be clear to the skilled person that a computer apparatus may be provided comprising a computer program product comprising a computer readable medium storing such a computer program, and that such a computer apparatus may be operatively coupled to the production machine, e.g. by means of a channel for communicating data and control signals. It is considered implicit that the computer apparatus comprises a computer processor.

In a further developed aspect, the steps of the method may be repeated over a plurality of iterations. Referring to FIG. 1, this further developed aspect could be obtained by not stopping execution of the method after step 107, but rather returning to step 101. On subsequent iterations of the method flow, the current values 108 may have been updated by a previous iteration. Likewise, the production machine 110 is in a different state compared to the previous iteration, and thus the output 111 is most likely also different compared to the previous iteration.

Preferably, the method is halted when a predefined halting criterium is reached, e.g. when the value of the above-described loss function is below a predefined threshold. Preferably, the method may be started or restarted when a predefined starting criterium is reached, e.g. when the value of the above-described loss function is above the predefined threshold.

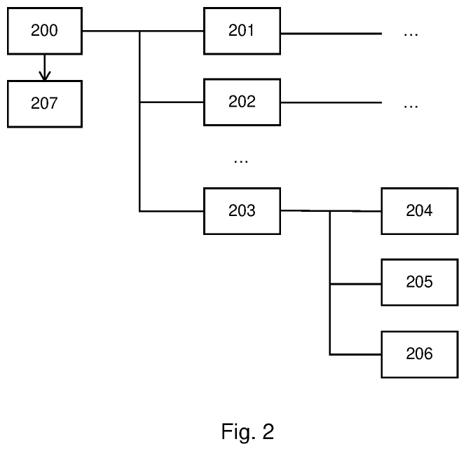

FIG. 2 schematically illustrates a production machine 200 having multiple parameters 201-203 for optimising using an aspect of a method according to the present disclosure, for example the same method 100 as in FIG. 1, in which case the production machine 200 would function as production machine 110 of FIG. 1.

The figure shows that production machine 200 leads to output 207, using a number of parameters of the production machine 200, of which three are shown: parameter 1, indicated with reference 201; parameter 2, indicated with reference 202; and parameter N, indicated with reference 203. Of course, the symbol N indicates that there may be any number of parameters of the production machine 200, which is indicated with an ellipsis sign between parameter 2 and parameter N.

For the sake of clarity, several features are shown only for parameter N, but analogous features may exist for the other parameters, for which analogous considerations apply.

Parameter N is coupled with a predefined step size N, indicated with reference 204. The step size N may for example be a step size of minimal or convenient granularity for the parameter N. In a particular example, for example if parameter N represents oven temperature, the step size N may be 0.1 degree Celsius if that is the minimum step size allowed by the production machine 200, or it may be 0.5 or 1 degree Celsius if that is a convenient step size for the operator or for the optimisation by the aspect of a method according to the present disclosure. In further developed aspects, the step size N may, over the course of the optimisation, be increased or decreased, if that is deemed useful for the optimisation. For example, early on during the optimisation, it may be advantageous to use a relatively larger step size, e.g. 5 degrees Celsius, as a convenient granularity, whereas later on during the optimisation, it may be advantageous to use a relatively smaller step size, e.g. 0.5 degrees Celsius, as the convenient granularity.

Parameter N is also coupled with current value X_{N}, indicated with reference 205, which represents the current value of parameter N as set in the production machine 200. Parameter N is further also coupled with modification value MN, indicated with reference 206, which is randomly determined and serves for modifying the current value X_{N} of parameter N. Preferably, modification value MN is randomly determined in [X_{N}−kS_{N}, X_{N}+kS_{N}] with k a natural number, preferably 1, i.e. from at least one respective step size S_{N} below the current value X_{N} of the parameter N to at least one respective step size S_{N} above the current value X_{N} of the parameter N.

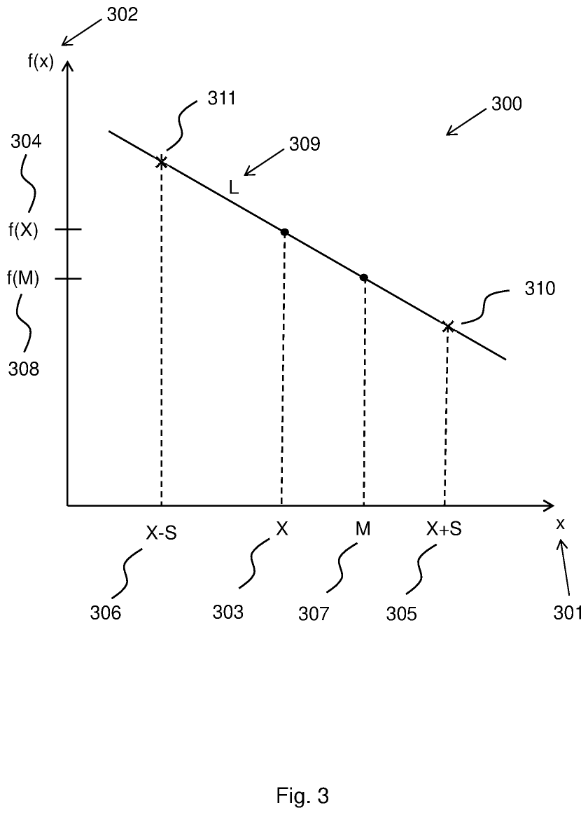

FIG. 3 schematically illustrates a graph 300 of a parameter of a production machine, for example the same production machine 200 as in FIG. 2, being optimised during operation of an aspect of a method according to the present disclosure, for example the same method 100 as in FIG. 1.

The graph 300 shows on its horizontal axis a parameter x 301 of the production machine, and on its vertical axis a function f of 302 of parameter x 301, representing the (partial) impact of parameter x 301 on the output of the production machine. The graph 300 further shows current value X 303 of the parameter x 301, which results in output impact f(X) 304.

During operation of the aspect of the method according to the present disclosure, a modification value M 307 is randomly determined within a range X−kS 306 to X+kS 305, i.e. from at least one respective step size S below the current value X of the parameter x to at least one respective step size S above the current value X of the parameter x. The parameter x of the production machine may then be set to this modification value. The resulting output impact f(M) 308 may be evaluated, and a linear slope L, representing an approximation of the derivative of the parameter x, may be determined based on f(X) 304 and f(M) 308. Based on the linear slope L, estimations may be made (shown with crosses) of estimated output impacts f(X−kS) 311 and f(X+kS) 310. Based on which of those output impacts is most likely to lead to an overall improved impact on the output of the production machine, parameter x may subsequently be modified by at least its step size S.

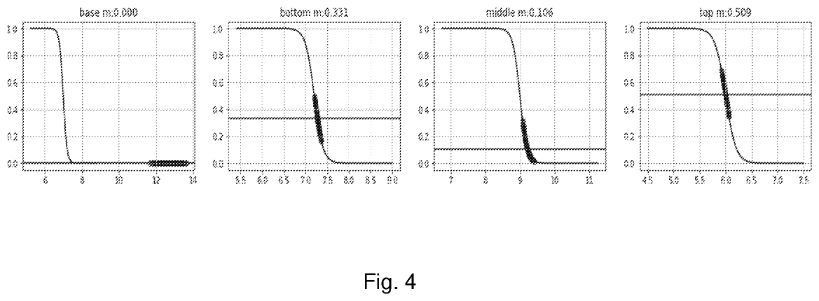

FIG. 4 schematically illustrates in four graph panes an example of a loss function for use in an aspect of a method according to the present disclosure, for example the same method as in FIG. 1.

The example loss function is applied in the specific example of a stretch blow machine as described above, and, as is shown here, it takes into account material thickness on the base, bottom, middle and top parts of a plurality of bottles.

Each dot represents a bottle (due to the high number of bottles, the adjacent dots in the figure appear smeared out as a bold section of the curve). It can be seen from the figure that a sigmoid form is used for the example loss function, although other forms may also be used.

In each pane, a horizontal line is also shown, which indicates the value to which the loss function is optimising, in the sense that the sum of the heights of those horizontal lines is the value of the loss function for the plurality of bottles. As can be seen from the figure, this particular example loss function affords the optimisation process with relatively more flexibility with regard to the base part of the bottle in order to better optimise the other parts of the bottle, because at the base part of the bottle, thickness may be reduced (i.e. the dots may shift to the left on the horizontal axis) with only an insignificant change to the loss function's result.

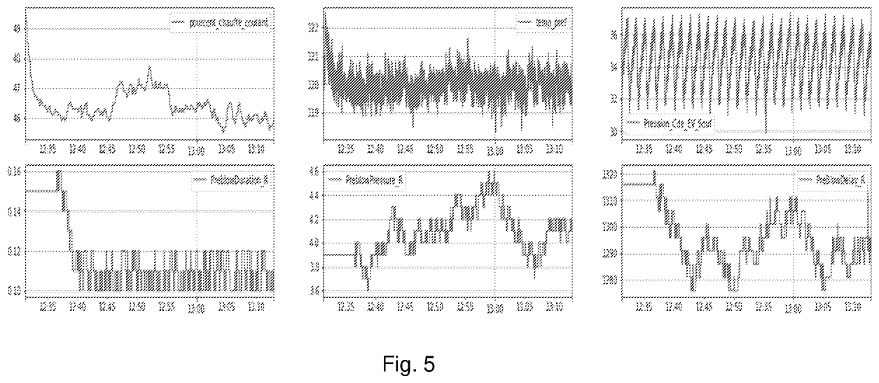

FIG. 5 schematically illustrates in six graph panes an example of six parameters of a production machine, for example the same production machine 200 as in FIG. 2, during operation of an aspect of a method according to the present disclosure, for example the same method as in FIG. 1.

In the figure, the top three panes show passive parameters, i.e. parameters that are not modifiable by the optimisation method, and the bottom three panes show active parameters, i.e. parameters that are modifiable by the optimisation method.

It is noted that during the first minutes of the depicted experiment, the active parameters were not yet modified, which is visible as a horizontal line until around timepoint 12:36.

It can be seen from the figure that the optimisation method modifies the active parameters repeatedly, searching for an optimum situation, by modifying the active parameters by their respective step sizes. In this particular experiment, each modification was done with the step size, although in other examples, some or all of the modifications may be done with multiples of the step size, if this is convenient.

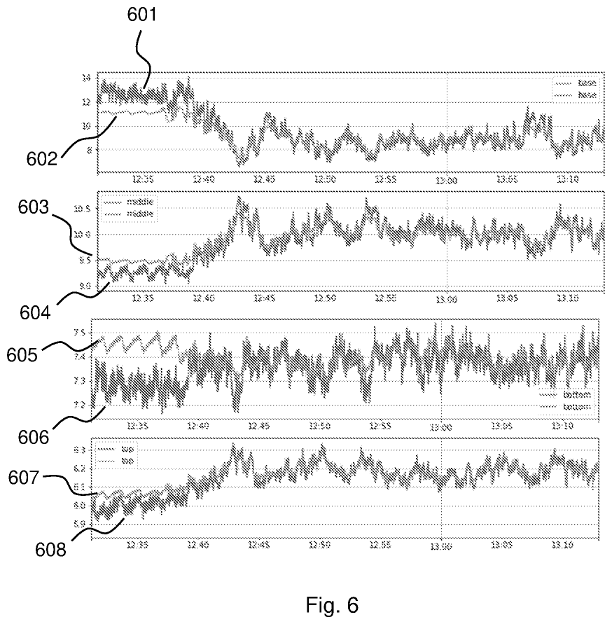

FIG. 6 schematically illustrates in four graph panes an example of plastic material distribution of a bottle during operation of an aspect of a method according to the present disclosure, for example in this case the same method as in FIG. 5.

Again in the context of the specific example of a stretch blow machine as described above, the first pane from the top of the figure represents material thickness of the base part of the bottle, the second pane the middle part of the bottle, the third pane the bottom part of the bottle, and the fourth pane (i.e. the bottom pane) the top part of the bottle.

Each pane shows the actual measured thickness, as part of evaluating the output of the production machine, as curves 601, 604, 606 and 608 respectively, as well as the respective linear function model of the thickness, fitted for the available training data of thickness measurements, as curves 602, 603, 605 and 607 respectively.

It can be seen that the linear function model over time, through small discrete modifications, comes to approximate the actual measured thickness quite closely due to using a time-decaying function of the sample weights, even though the actual measured thickness fluctuates quite strongly sometimes.

1. A method (100) for optimising at least one parameter (301) of a production machine (110), comprising:
randomly determining (101) at least one modification value for modifying a respective current value of the at least one parameter, wherein the at least one modification value is based on the respective current value (303) of the at least one parameter and on a respective step size (S) predefined for the at least one parameter;
modifying (102), at the production machine, the at least one parameter to its respective modification value;
evaluating (103) an output (111, 304) of the production machine, wherein the output is effected using the at least one modified parameter;
fitting (104) a linear function model for the at least one parameter, based on the evaluated output;
estimating (105), using the linear function model, at least one impact (308) on the output of the production machine, for the at least one parameter if the respective parameter is modified by at least the respective predefined step size;
determining (106) whether or not to modify, at the production machine, the at least one parameter by at least its respective predefined step size, based on a desired output of the production machine, taking into account the at least one estimated impact; and
if it is determined to modify the at least one parameter, modifying (107) the at least one parameter by at least its respective predefined step size.

2. The method of claim 1, wherein the at least one modification value is randomly determined in the following range: from at least one respective step size below the respective current value of the at least one parameter to at least one respective step size above the respective current value of the at least one parameter.

3. The method of claim 1, comprising repeating the steps of the method over a plurality of iterations.

4. The method of claim 1, wherein the linear function model is fitted for the at least one parameter further based on at least one previously evaluated output and on at least one previous setting of the at least one parameter of the production machine corresponding with the at least one previously evaluated output.

5. The method of claim 4, wherein a sample importance weight of the at least one previously evaluated output and the at least one previous setting decreases over time according to a time-decaying function.

6. The method of claim 1, wherein the at least one impact is estimated by approximating at least one derivative of the at least one parameter and determining at least one value of the at least one approximated derivative if the respective parameter is modified by at least its respective predefined step size.

7. The method of claim 1, wherein the at least one parameter is a plurality of parameters.

8. The method of claim 1, comprising executing a heuristic configured for determining an optimal combination of modifications of the at least one parameter for approaching the desired output, taking into account the at least one estimated impact.

9. The method of claim 8, wherein determining whether or not to modify the at least one parameter comprises minimising or maximising a loss function.

10. The method of claim 3, wherein the respective predefined step size changes at least once over an iteration of the plurality of iterations.

11. The method of claim 1, wherein the respective predefined step size is determined for the at least one parameter based on a minimally distinguishable discrete granularity of the at least one parameter at the production machine.

12. A computer program comprising instructions configured for, when executed on a computer processor, performing the method of claim 1.

13. A computer program product comprising a computer readable medium storing the computer program of claim 12.

14. A computer apparatus comprising the computer program product of claim 13 and configured for performing the method of claim 1.

15. A production machine (110, 200) operatively coupled to the computer apparatus of claim 14.

16. The method of claim 6, wherein the at least one approximated derivative is a gradient.
